(19) United States
(12) Patent Application Publication
(10) Pub. No.: US 2010/0265211 A1
(43) Pub. Date: Oct. 21, 2010

(54) TOUCH-TYPE INPUT DEVICE

(75) Inventors: Yuki OISHI, Ukyo-Ku (JP); Satoshi MAEJIMA, Ukyo-Ku (JP)

Correspondence Address: CANTOR COLBURN, LLP, 20 Church Street, 22nd Floor, Hartford, CT, 06103, US

(73) Assignee: ROHM CO., LTD., Kyoto (JP)

(21) Appl. No.: 12/759,732

(22) Filed: Apr. 14, 2010

(30) Foreign Application Priority Data
Apr. 15, 2009 (JP) JP 2009-099243
Mar. 25, 2010 (JP) JP 2010-070795

(51) Int. Cl. G06F 3/044

(52) U.S. Cl. 345/174

(57) ABSTRACT

In a touch-type input device, multiple sensor electrodes are arranged in a first coordinate axis direction. A capacitance detection circuit measures the electrostatic capacitances of the multiple sensor electrodes, and generates a first data array containing the capacitance value data which represents the electrostatic capacitances thus measured. A peak detection unit scans the first data array, identifies the sensor electrode which exhibits the largest capacitance, and generates first peak data which indicates the sensor electrode thus identified. Using the sensor electrode indicated by the first peak data as a reference, a computation processing unit reduces the value of the capacitance data of each sensor electrode arranged in a range within the capacitance value data contained in the first data array so as to generate a second data array, with the range having been selected using the sensor electrode indicated by the first peak data as a reference. A peak detection unit scans the second data array so as to generate second peak data.

### BACKGROUND OF THE INVENTION

1. Field of the Invention

The present invention relates to a touch-type input device using change in electrostatic capacitance.

2. Description of the Related Art

In recent years, it has become mainstream for electronic devices such as computers, cellular phone terminals, PDAs (Personal Digital Assistants), etc., to include an input device which allows the user to operate the electronic device by using the fingers to touch the input device.

A touch-type input device (which is also referred to as a “touch sensor”, “touchpad”, or “trackpad”), which is one of such input devices, includes an electrostatic sensor using a mechanism in which the electrostatic capacitance formed around the electrodes changes due to being touched by the user's fingers. The touch-type input device includes multiple sensor electrodes arranged along the X-axis direction, multiple sensor electrodes arranged along the Y-axis direction, and a detection circuit configured to detect the electrostatic capacitance that occurs at each electrode. The detection circuit identifies sensor electrodes where there has been a large change in the electrostatic capacitance, i.e., sensor electrodes which the user has touched, thereby detecting positions which the user has touched.

In recent years, such user interfaces have become capable of receiving various kinds of input processing (gestures) via the user touching multiple positions using multiple fingers at the same time, and via the user moving the fingers while continuing to touch the user interface. For example, when the user touches the touch-type input device using two fingers, there are two points having large changes in capacitance at two positions along the X-axis direction and the Y-axis direction. In this case, the detection circuit must identify the points where there have been large changes in capacitance in order to identify the gesture which the user has input. The related technique is disclosed in Patent document 3.

### RELATED ART DOCUMENTS

### Patent Documents

[patent document 1]

Japanese Patent Application Laid Open No. 2001-325858

[patent document 2]

PCT Japanese Translation Patent Publication No. 2003-511799

[patent document 3]

U.S. Pat. No. 5,825,352 A1 Specification

[patent document 4]

Japanese Patent Application Laid Open No. 2007-013432

### [Patent Document 5]

Japanese Patent Application Laid Open No. H11-232034

With the techniques described in Patent document 3, an input operation made using multiple fingers is detected by the following steps.

Step 1. The largest value (maxima) of the change in capacitance is detected, which corresponds to the first finger.

Step 2. The smallest value (minima) following the largest value thus detected in Step 1 is detected.

Step 3. The second largest value following the smallest value thus detected in Step 2 is detected, which corresponds to the second finger.

In the technique described in Patent document 3, the processing in Step 2 for detecting the smallest value is important. However, simple processing cannot be employed in this processing to detect the smallest value. This is because, when the user touches the touch-type input device using multiple fingers, the smallest value can occur at other positions in addition to the position between the user's fingers. Accordingly, there is a need to provide a complicated algorithm to detect the smallest value in Step 2. This can lead to problems such as an increased circuit scale, increased power consumption, and reduced processing speed.

### SUMMARY OF THE INVENTION

The present invention has been made in order to solve such a problem. Accordingly, it is an exemplary purpose of the present invention to provide a touch-type input device which is capable of detecting input operations made using multiple fingers in a simpler manner.

An embodiment of the present invention relates to a touch-type input device. The touch-type input device comprises: multiple sensor electrodes arranged in a first coordinate axis direction, each of which is configured such that its electrostatic capacitance changes according to the circumstances of how a user touches the sensor electrodes; a capacitance detection circuit configured to measure the electrostatic capacitances of the multiple sensor electrodes, and to generate a first data array containing capacitance value data which represents the electrostatic capacitances thus measured; a peak detection unit configured to scan the first data array, to identify the sensor electrode which exhibits the largest capacitance value, and to generate first peak data which represents the sensor electrode thus identified; and a computation processing unit configured to reduce the value of the capacitance data of each sensor electrode arranged in a range within the capacitance data contained in the first data array so as to generate a second data array, with the range having been selected using the sensor electrode indicated by the first peak data as a reference. With such an arrangement, the peak detection unit scans the second data array, identifies the sensor electrode which exhibits the largest capacitance value, and generates second peak data which represents the sensor electrode thus identified.

With such an embodiment, the positions of the user's two fingers can be identified based upon the first peak data and the second peak data. This processing requires only detection of the largest value in the first data array and the largest value in the second data array. That is to say, this processing does not require processing for detecting the smallest value, thereby providing simple processing.

Also, the computation processing unit may reduce the value of the capacitance data that correspond to each sensor electrode arranged in the range to a predetermined value. The predetermined value is a value which is lower than the second highest peak of the capacitance value, which corresponds to the second peak data.

With an embodiment, also, the predetermined value may be a judgment threshold value which is used to judge whether each sensor electrode is on or off.

If the capacitance value that corresponds to the second peak data is lower than the judgment threshold value used to judge whether each sensor electrode is on or off, the second peak data does not correspond to a valid touch operation. Accordingly, there is no need to detect such second peak data. Thus, by reducing the capacitance values in the vicinity of the first peak data to the judgment threshold value used to judge whether each sensor electrode is on or off, such an arrangement is capable of detecting valid second peak data in a sure manner.

Furthermore, with an arrangement in which the position of the user's finger is identified by calculating the centroid of the capacitance, such processing enables the calculation of the coordinate position of the user's finger to be made with higher precision.

With an embodiment, also, the predetermined value may be zero. With such an arrangement, the capacitance values in the vicinity of the first peak data can be reduced to a value smaller than the second peak in a sure manner.

Alternatively, the computation processing unit may subtract a predetermined value from the value of the capacitance data that corresponds to each sensor electrode arranged in the range.

The range may be a range of which the start point is set to the first peak coordinate position. Also, the range may be a range of which the end point is set to a coordinate position a predetermined distance away from the first peak coordinate position in the direction opposite to the scanning direction.

Such processing enables the coordinate position of each finger to be detected with high precision even if the user touches the touch-type input device with two adjacent fingers.

The range may be a range of which the center is set to the first peak coordinate position.

Also, the range may be determined based upon the width of a standard user's finger and the intervals between the multiple sensor electrodes.

Another embodiment of the present invention relates to a control method for a touch-type input device having multiple sensor electrodes arranged in a first coordinate axis direction. The control method comprises the following steps.

A first step in which the electrostatic capacitances of the multiple sensor electrodes are measured, and a first data array is generated, containing capacitance value data which represents the electrostatic capacitances thus measured.

A second step in which the first data array is scanned, and the sensor electrode which exhibits the largest capacitance value is identified.

A third step in which the value of the capacitance data of each sensor electrode arranged in a range within the capacitance data contained in the first data array is reduced, using the sensor electrode identified in the second step as a reference, so as to generate a second data array.

A fourth step in which the second data array is scanned, and the sensor electrode which exhibits the largest capacitance value is identified.

Yet another embodiment of the present invention relates to a touch-type input device provided at such a position that it is overlaid on a circuit which functions as a source of noise. The touch-type input device has a structure in which a substrate, sensor electrodes, and a cover which covers the sensor electrodes are layered in this order. The cover has a higher dielectric constant than that of the substrate.

With such an embodiment, the capacitance that occurs between the sensor and the source of noise can be reduced as compared with the capacitance that occurs between the sensor and the user's finger. Thus, such an arrangement improves the S/N ratio.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a block diagram which shows a configuration of an electronic apparatus including a touch-type input device according to an embodiment;

FIG. 2 is a plan view and a cross-sectional view showing a structure of a sensor unit;

FIG. 3 is a block diagram which shows a configuration of a touch-type input device according to a first embodiment;

FIG. 4 is a diagram which shows the processing flow performed by the input device shown in FIG. 3;

FIGS. 5A through 5E are diagrams which show the processing performed by a computation processing unit;

FIG. 6 is a cross-sectional view which shows a structure of a sensor unit of an input device according to a second embodiment;

FIG. 7 is a block diagram which shows a configuration of an IC that corresponds to a capacitance detection circuit;

FIG. 8 is an explanatory diagram showing an detection IC;

FIG. 9 is a circuit diagram showing peripheral components for the detection IC;

FIG. 10 is a block diagram which shows a configuration of a clock control unit;

FIG. 11 is a state transition diagram which shows three modes; and

FIGS. 12A through 12C are diagrams for describing a resolution setting function.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

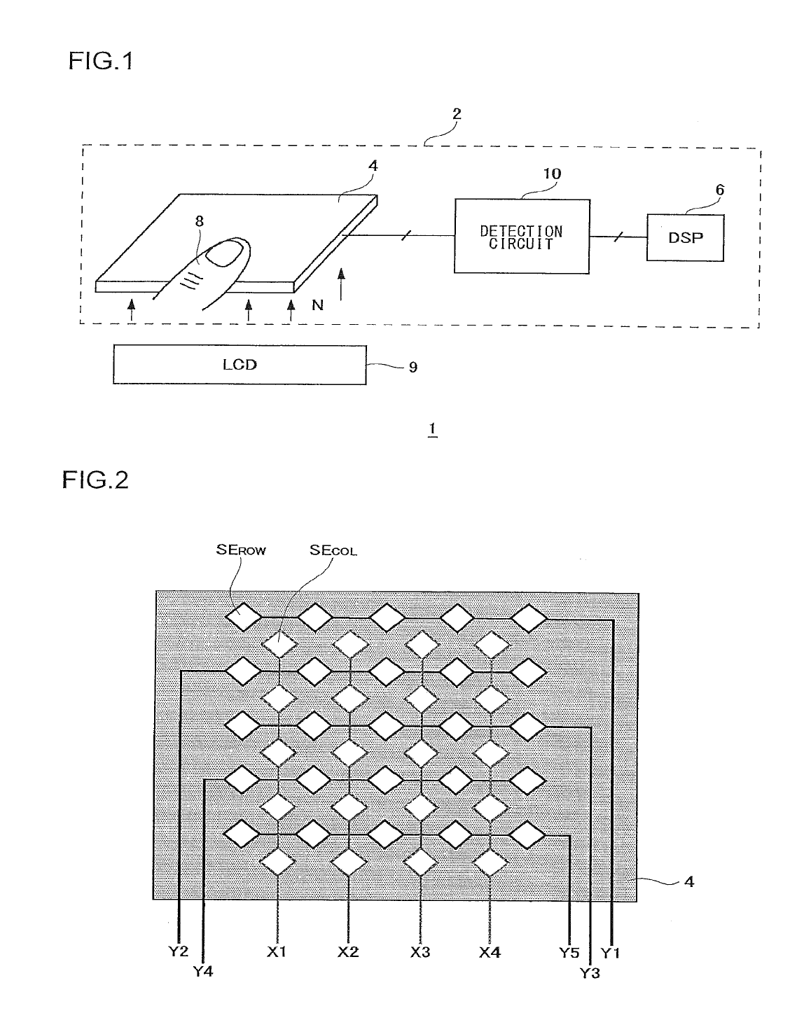

FIG. 1 is a block diagram which shows a configuration of an electronic device 1 including a touch-type input device 2 according to an embodiment. The input device (touch-type input device) 2 is arranged at such a position that it is overlaid on an LCD (Liquid Crystal Display) 9, i.e., such that it is arranged as a surface layer of the LCD 9, thereby providing a function as a touch panel. Alternatively, the touch-type input device 2 may be configured as a trackpad arranged at a position separate from the LCD 9.

The input device 2 includes a sensor unit 4, a capacitance detection circuit 10, and a DSP (Digital Signal Processor) 6. When the user touches the surface of the sensor unit 4 using a finger 8, a sensor electrode (not shown) arranged as an internal component of the sensor unit 4 changes shape or position, thereby changing the electrostatic capacitance formed around the electrode. The sensor unit 4 may be configured as a switch including a single sensor electrode, or may be configured as a sensor electrode array formed of multiple sensor electrodes arranged in the form of a matrix. It should be noted that the capacitance detection circuit 10 and the DSP 6 may be monolithically integrated.

The capacitance detection circuit 10 detects changes in the electrostatic capacitance around the sensor electrode, and outputs data that corresponds to the detection result to the DSP 6. The DSP 6 analyzes the data received from the capacitance detection circuit 10, and judges whether or not the user has performed an input operation, and identifies what kind of input operation the user has performed. For example, when the user's finger 8 touches the sensor unit 4, an item or an object is selected from the items or objects displayed on the LCD 9, or a text input operation is supported.

### First Embodiment

Description will be made regarding an input device 2 according to a first embodiment which allows the user to perform an input operation using the user's multiple fingers.

FIG. 2 is a plan view and a cross-sectional view which shows a structure of the sensor unit 4. FIG. 2 is a plan view as viewed from the top. The sensor unit 4 includes multiple sensor electrodes SE. The sensor electrodes SE are composed of five row electrodes (black) SE_{ROW} arranged in the row direction for detecting input operation positions along the row direction, and four column electrodes (gray) SE_{COL} arranged in the column direction for detecting input operation positions along the column direction. The numbers of row electrodes and column electrodes are described for exemplary purposes only, to facilitate understanding. The numbers of row electrodes and column electrodes may be determined as desired.

A signal line Yi is drawn out from the i-th (i is an integer) row electrode SE_{ROW}, and a signal line Xj is drawn out from the j-th column electrode SE_{COL}. The above is the structure of the sensor unit 4.

When the user touches the sensor unit 4 with a finger, the electrostatic capacitance changes at the sensor electrode SE immediately below the user's finger. When the user touches the sensor unit 4 with multiple fingers, the electrostatic capacitance changes at the corresponding sensor electrode SE immediately below each finger.

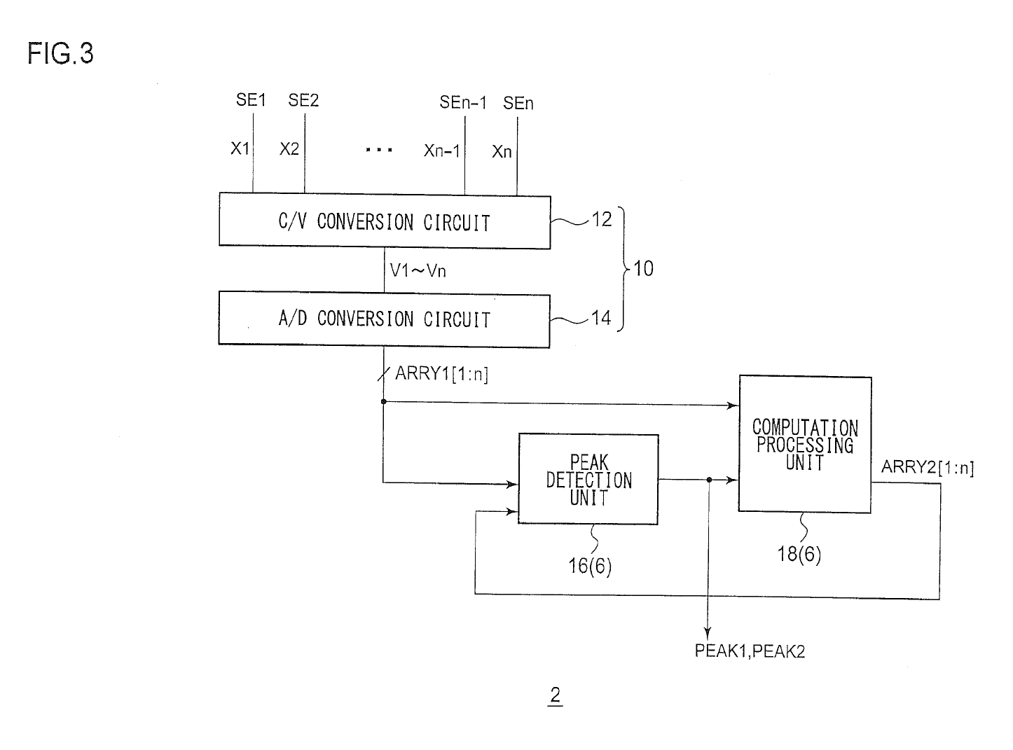

FIG. 3 is a block diagram which shows a configuration of the touch-type input device 2 according to the first embodiment. FIG. 3 shows the configuration of only the blocks that relate to components arranged in a first direction (X-axis direction). The configuration for the second direction (Y-axis direction) can be made in the same way, which can be readily conceived by those skilled in this art.

The input device 2 includes multiple sensor electrodes SE, a capacitance detection circuit 10, a peak detection unit 16, and a computation processing unit 18.

As described above, n (n is an integer of 2 or more) sensor electrodes SE are arranged along the first axis direction (X-axis direction). The electrostatic capacitances C1 through Cn change according to the circumstances of how the user touches the input device 2.

The capacitance detection circuit 10 is connected to signal lines X1 through Xn, and measures the electrostatic capacitances of the sensor electrodes SE1 through SEn and generates a capacitance data array (first data array ARRAY1 [1:n]) which represents the electrostatic capacitances C1 through Cn thus measured.

For example, the detection circuit 10 includes a capacitance/voltage (C/V) conversion circuit 12 and an analog/digital (A/D) conversion circuit 14.

The C/V conversion circuit 12 sequentially scans the multiple sensor electrodes SE1, SE2, measures the electrostatic capacitances thereof, and generates analog voltage signals V1, V2, . . . , which represent the electrostatic capacitances thus measured. The C/V conversion circuit 12 can be configured using known techniques, and the configuration thereof is not restricted in particular. The A/D conversion circuit 14 converts the analog voltage signals V1, V2, . . . , into digital capacitance data D1, D2, . . . . The i-th component of the first data array ARRAY1 [1:n] corresponds to the capacitance data Di which represents the capacitance value of the i-th sensor electrode SEi.

The peak detection unit 16 scans the first data array ARRAY1 [1:n], identifies the sensor electrode SE which exhibits the largest capacitance value, and generates first peak data PEAK1 which indicates the sensor electrode SE thus identified. The first peak data PEAK1 is data that corresponds to the position (coordinate point) of the user's first finger.

Using the sensor electrode SE1 indicated by the first peak data PEAK1 as a reference, the computation processing unit 18 reduces the capacitance data D of the sensor electrodes SEL arranged in a range within the capacitance data D1 through Dn contained in the first data array ARRAY1 [1:n], so as to generate a second data array ARRAY2 [1:n].

The second data array ARRAY2 [1:n] is input to the peak detection unit 16. The peak detection unit 16 scans the second data array ARRAY2 [1:n], identifies the sensor electrode SE which exhibits the largest capacitance value, and generates second peak data PEAK2 which indicates the sensor electrode SE thus identified. The second peak data PEAK2 is data that corresponds to the position (coordinate point) of the user's second finger.

It should be noted that the peak detection unit 16 and the computation processing unit 18 may be configured as a block that corresponds to the DSP 6 shown in FIG. 1.

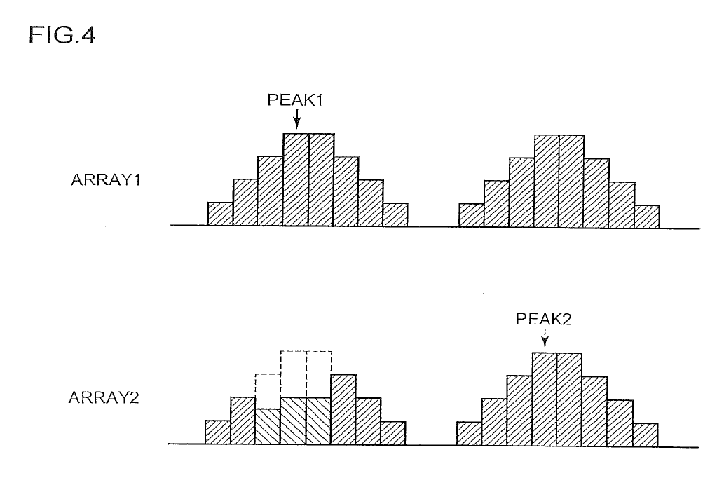

FIG. 4 is a diagram which shows the processing flow performed by the input device 2 shown in FIG. 3. FIG. 4 shows the data array ARRAY1 and ARRAY2. The horizontal axis represents the coordinate positions of the multiple sensor electrodes SE, and the vertical axis represents the capacitance value of each sensor electrode SE.

As described above, with the input device 2 shown in FIG. 3 and the control method thereof, the positions of the user's two fingers can be detected based upon the first peak data PEAK1 and the second peak data PESK2.

With such a method, processing for detecting the largest value is performed twice, and subtraction processing is performed once. Thus, there is no need to perform processing for detecting the smallest value that occurs between the user's fingers, unlike conventional arrangements. As described above, the processing for detecting the smallest value between the adjacent peaks requires a complicated algorithm such as differential processing or the like. In some cases, such an arrangement requires a complicated circuit, leading to large power consumption. In contrast, the input device 2 according to the embodiment has the advantage of a simple circuit configuration, and the advantage of reduced power consumption.

Also, the peak detection unit 16 and the computation processing unit 18 may generate third peak data or further higher-order peak data by recursively performing the above-described processing. Specifically, the peak detection unit 16 and the computation processing unit 18 may repeatedly perform the following processing while incrementing the integer j.

Step 1. The peak detection unit 16 scans the j-th data array ARRAYj[1:n], and generates the j-th peak data PEAKj.

Step 2. Using the sensor electrode indicated by the j-th peak data PEAKj as a reference, the computation processing unit 18 reduces the value of the capacitance data of each sensor electrode arranged in a range within the capacitance data contained in the j-th data array ARRAYj [1:n], so as to generate the (j+1)-th data array ARRAYj+1[1:n].

Step 3. The integer j is incremented.

With such processing, an input operation performed using three or more fingers can be appropriately detected. That is to say, such an arrangement has the advantage of improved expandability with respect to simultaneous input operations.

Next, description will be made regarding a specific example of the processing performed by the computation processing unit 18.

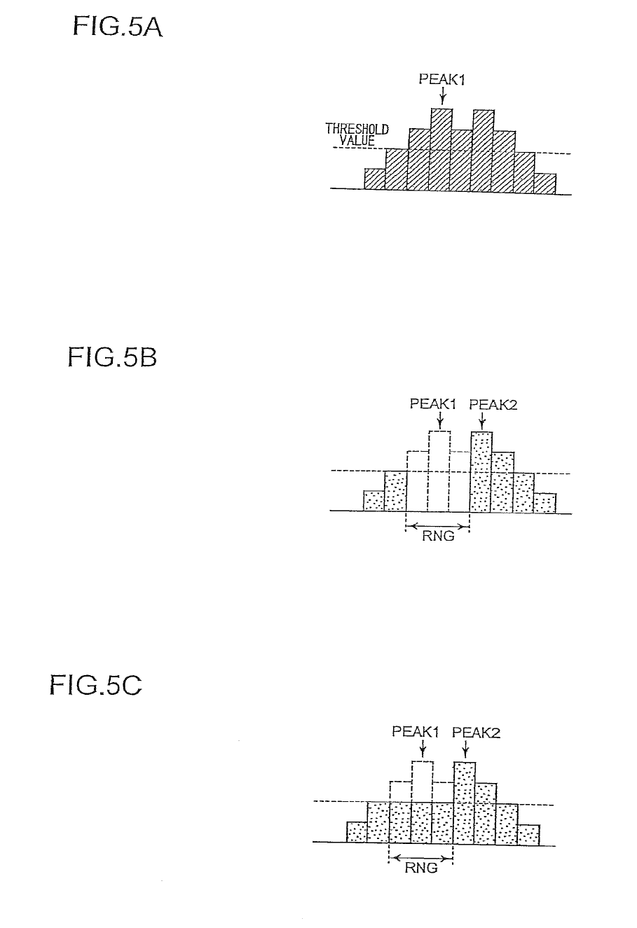

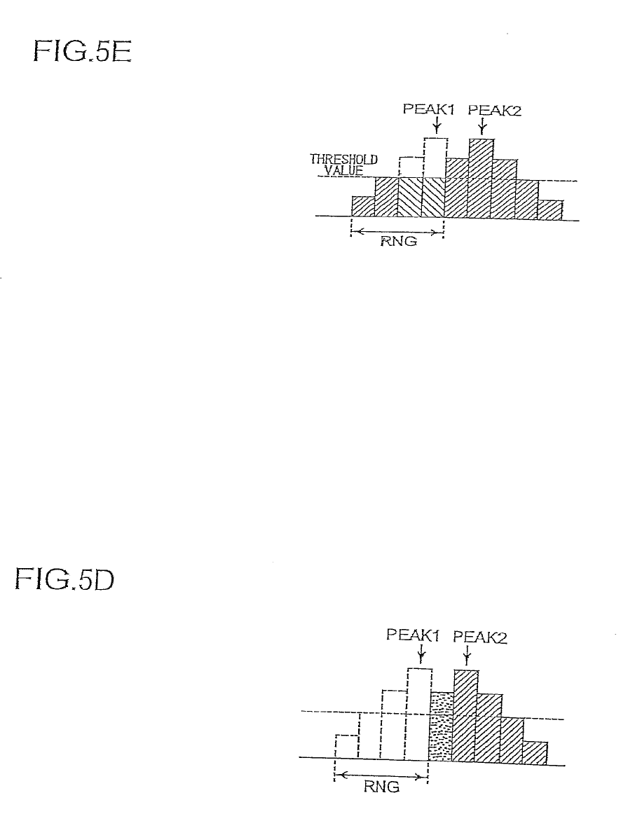

FIGS. 5A through 5E are diagrams which show the processing performed by the computation processing unit 18. FIG. 5A shows the first data array ARRAY1. FIGS. 5B through 5E show the second data array ARRAY2 generated in the first through fourth processing.

As shown in FIGS. 5B through 5E, the computation processing unit 18 reduces the values of the capacitance data that correspond to the sensor electrodes within a range RNG, for which the first peak data PEAK1 is a reference, to a predetermined value.

As shown in FIGS. 5B and 5D, the predetermined value may be zero. Also, in a case in which an ON/OFF threshold value is set for the capacitance value of each sensor electrode SE, the predetermined value may be set to this threshold value, as shown in FIGS. 5C and 5E.

In some cases, the centroid of the capacitance is calculated so as to detect the coordinate position of each finger, instead of directly using the values of the first peak data PEAK1 and the second peak data PEAK2 as the coordinate positions of the user's fingers. In such a case, as shown in FIGS. 5C and 5E, the predetermined value is set to a non-zero value, which allows the centroid to be calculated with higher precision.

The following settings may be made with respect to the range RNG.

For example, as shown in FIGS. 5B and 5C, with the sensor electrode SE indicated by the first peak data PEAK 1 as the center, the range RNG may have left and right regions which each include a predetermined number of sensor electrodes (in FIG. 5, one).

Alternatively, as shown in FIGS. 5D and 5E, the range RNG may be set to a range with the sensor electrode indicated by the first peak data PEAK1 as one end, and with the other end as a sensor electrode a predetermined distance (in FIG. 3, four sensor electrodes) away in the direction opposite to the scanning direction (e.g., the right direction).

With such an arrangement, in the step where the second data array ARRAY2 is generated, the values of the capacitance data on the right side of the sensor electrode indicated by the first peak data PEAK1 are not reduced. Thus, such an arrangement is capable of detecting the coordinate position of the user's second finger even if the coordinate position of the second peak (i.e., PEAK2) is very close to the user's first finger (i.e., PEAK1).

It should be noted that the range RNG is preferably determined based upon the width of a standard user's finger and the intervals between the multiple sensor electrodes SE.

### Second Embodiment

In a case in which the sensor unit 4 is provided as a surface layer of the LCD 9 as shown in FIG. 1, the internal sensor electrodes included within the sensor unit 4 are easily affected by noise N that occurs at the LCD 9. In a case in which such a noise component is superimposed on a signal that represents the change in the electrostatic capacitance, the sensor unit 4 cannot accurately identify the operation information from the user. It can be assumed that the sensor unit 4 can be affected by noise N that occurs at other circuit blocks provided as internal components of the electronic device 1 even if the sensor unit is not provided in the form of a surface layer of the LCD 9.

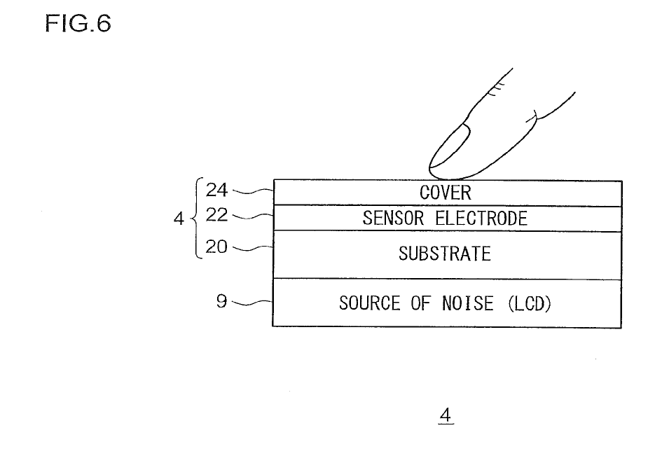

Detailed description will be made below regarding the input device 2 that is not subject to the effects of noise N. FIG. 6 is a cross-sectional diagram which shows a configuration of the sensor unit 4 included in the input device 2 according to a second embodiment.

The sensor unit 4 of the input device 2 is arranged at such a position that it is overlaid on a circuit (e.g., the LCD 9) which functions as a source of noise. A substrate 20, a sensor electrode layer 22, and a cover 24 are layered in this order. The sensor electrodes SE, signal lines X, and signal lines Y, described above, are formed in the sensor electrode layer 22.

In order to protect the sensor electrode layer 22, the cover 24 is provided as a surface layer via which the user can touch the input device 2. The substrate 20 is provided in order to support the sensor electrode layer 22. FIG. 6 shows an arrangement in which the substrate 20 and the LCD 9 are closely connected. Also, an air layer, which is referred to as an “air gap”, may be provided between the substrate 20 and the LCD 9.

In order to reduce the effects of noise in such a configuration, the dielectric constant ∈1 of the cover 24 is designed to be higher than the dielectric constant s2 of the substrate 20. That is to say, the materials for the cover 24 and the substrate 20 are selected such that the following relation is satisfied.

∈1>∈2 (1)

When the user's finger touches the input device 2, the electrostatic capacitance formed around the sensor electrode layer 22 changes. For example, when the user touches the sensor unit 4, electrostatic capacitance occurs between the sensor electrode layer 22 and the user's finger. The electrostatic capacitance C thus formed corresponds to the signal component to be detected by the input device 2, and is proportional to the contact area S and the dielectric constant ∈1.

At the same time, the substrate 20 arranged between the sensor electrode layer 22 and the LCD 9 functions as a parasitic capacitance which couples the LCD 9 to the sensor electrode layer 22. Noise that occurs at the LCD 9 propagates to the sensor electrode layer 22 via the parasitic capacitance, leading to degradation of the S/N ratio. The parasitic capacitance is proportional to the area where the LCD 9 is overlaid on the sensor electrode layer 22 and the dielectric constant s2.

Thus, the noise that propagates through the sensor electrode layer 22 can be reduced by reducing the dielectric constant ∈2 of the cover 24. On the other hand, the signal component can be raised by increasing the dielectric constant ∈1 of the cover 24. That is to say, the S/N ratio can be raised by configuring the sensor unit 4 such that the relation (1) is satisfied.

For example, glass can be suitably employed as the material of the cover 24. In addition to glass, plastic such as acrylic, PET (polyethylene terephthalate), etc., can be employed as the material of the substrate 20.

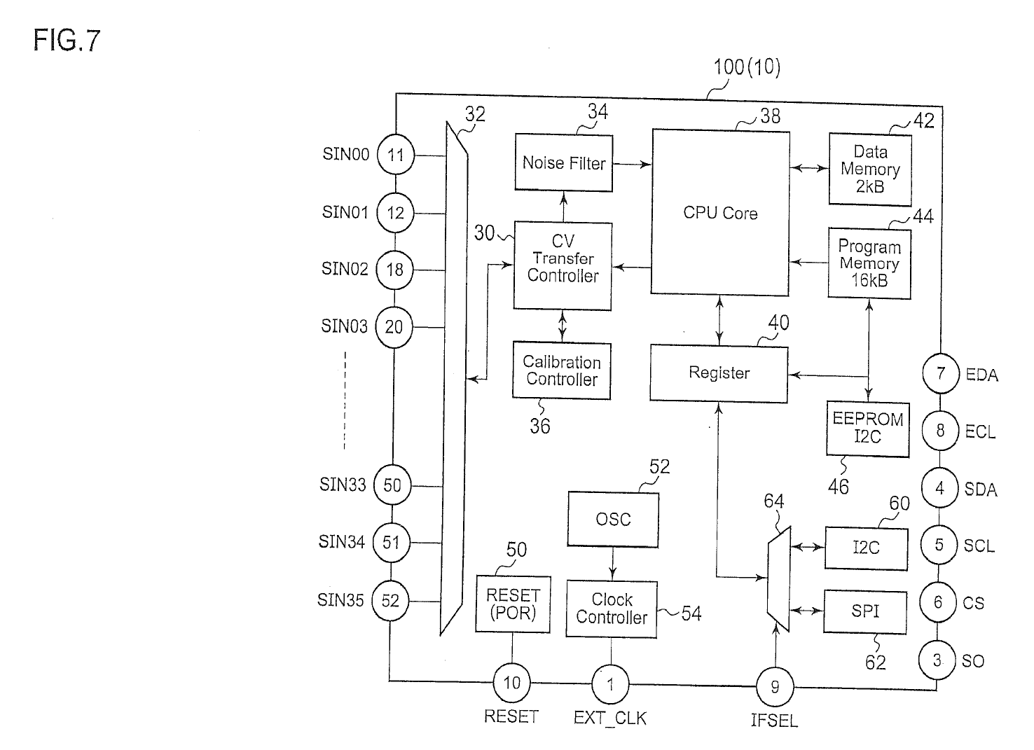

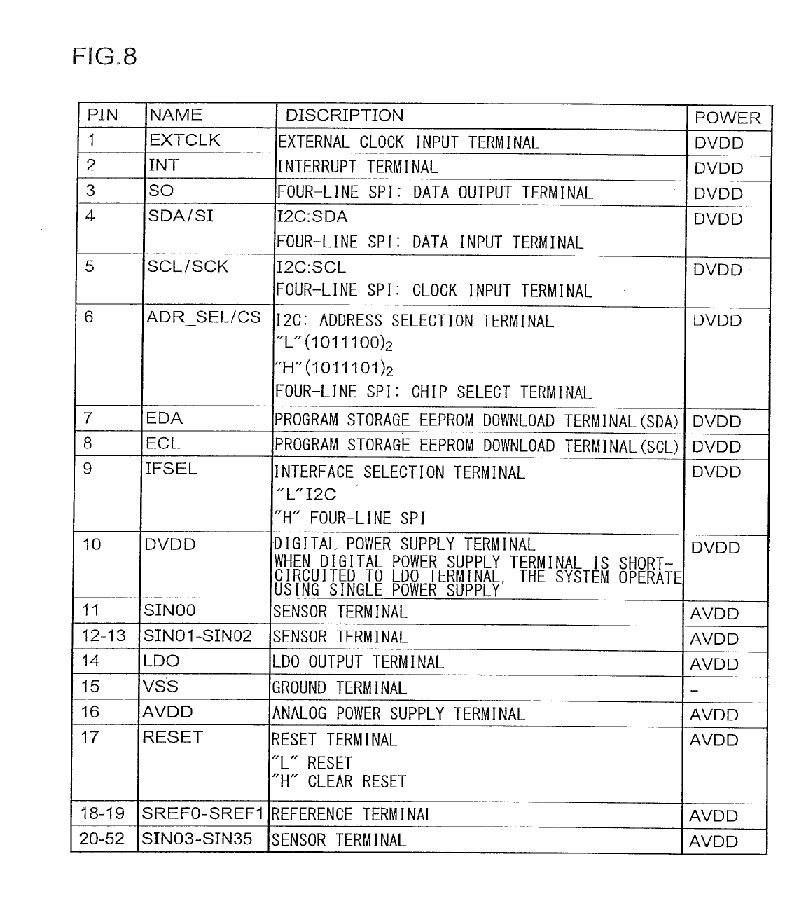

Next, description will be made regarding a detection IC 100 including the capacitance detection circuit 10. FIG. 7 is a block diagram which shows a configuration of the detection IC 100. FIG. 8 is an explanatory diagram which shows the terminals of the detection IC 100.

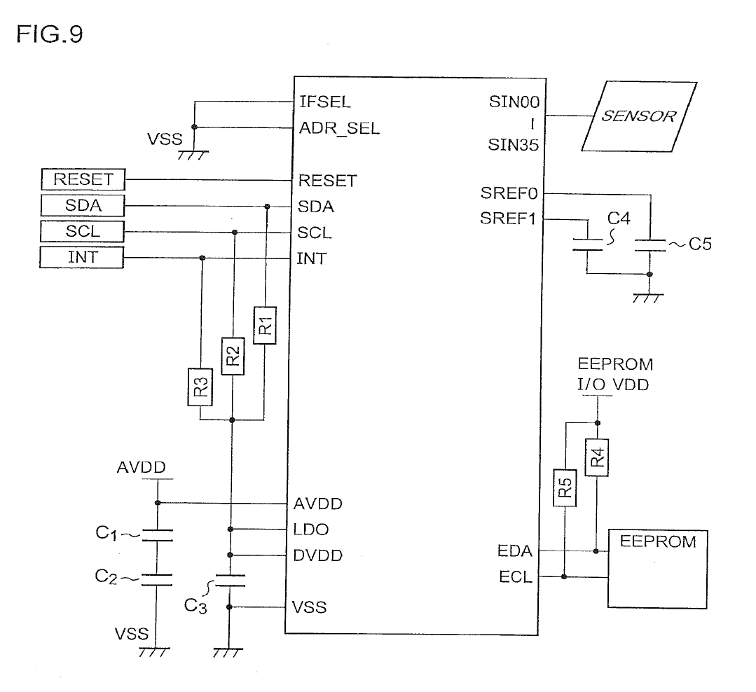

FIG. 9 is a circuit diagram which shows the peripheral components of the detection IC 100. An analog power supply voltage AVDD is supplied to an AVDD terminal from an external circuit. Capacitors C1 and C2 are provided between the AVDD terminal and an ground terminal VSS. The detection IC 100 includes an unshown internal regulator, and stabilizes the analog power supply voltage AVDD and outputs the power supply voltage AVDD thus stabilized via an LDO terminal. The voltage thus stabilized is supplied to a digital power supply terminal DVDD of the detection IC 100 itself. A capacitor C3 is provided between the DVDD terminal and the ground terminal VSS. Resistors R1 through R3 are respectively provided between a terminal SDA and the LDO terminal, between a terminal SCL and the LDO terminal, and between a terminal INT and the LDO terminal.

Reference capacitors C4 and C5 are respectively connected between an SREF0 terminal and the ground terminal VSS and an SREF1 terminal and the ground terminal VSS. A resistor R4 is provided between an EDA terminal and an I/O power supply terminal I/O_VDD. A resistor R5 is provided between an ECL terminal and the terminal I/O_VDD.

Returning to FIG. 7, the detection IC 100 includes a C/V conversion control unit 30, a multiplexer 32, a noise filter 34, a calibration control unit 36, a CPU core 38, a register 40, data memory 42, program memory 44, EEPROM 46, a reset unit 50, an oscillator 52, a clock control unit 54, an I²C interface 60, an SPI interface 62, and a selector 64.

The multiple sensor electrodes SE are connected to sensor terminals SIN. Furthermore, unshown reference electrodes (capacitors) are respectively connected to reference terminals SREF0 and SREF1 (not shown in FIG. 7).

The C/V conversion control unit 30 is a block that corresponds to the aforementioned capacitance detection circuit 10, which compares each sensor terminal SIN with the reference terminal SREF, and detects the difference in capacitance therebetween. The multiple sensor terminals SIN are connected to the multiplexer 32. The C/V conversion control unit 30 controls the multiplexer 32 so as to sequentially scan the multiple sensor terminals SIN.

The parasitic capacitance of each sensor is different, and the calibration control unit 36 corrects these irregularities in the parasitic capacitances. The noise filter 34 cancels out noise contamination from the sensor terminals. Specifically, the noise filter 34 includes a filter which limits the change in the input signal, and a moving average filter.

The CPU core 38 is a unit that corresponds to the aforementioned DSP 6, which calculates the touch panel XY coordinate position based upon the sensor value acquired by the C/V conversion control unit 30.

The data memory 42 is a working area used by the CPU core 38. The program memory 44 stores a program to be executed by the CPU core 38. This program is loaded into the program memory 44 from an external circuit via a host interface. Also, this program can be loaded from the EEPROM provided in the form of a built-in component. The detection IC 100 includes an I²C (inter IC) interface 60 and a four-line SPI (Serial Peripheral Interface) 62, each of which is provided as an interface which enables the detection IC 100 to communicate with an external circuit. The selector 64 is provided in order to switch between the two interfaces and 62. When a high level signal is input to an IFSEL terminal, the four-line SPI is selected, and when a low level signal is input to the IFSEL terminal, the I²C is selected. The data input via the I²C interface 60 or the SPI interface 62 is written to the register 40, and the data written to the register 40 is output to an external circuit via the I²C interface 60 or the SPI interface 62.

The reset unit 50 controls a power-on reset (POR) operation according to the power supply voltage and an external reset operation according to a signal input to a reset terminal REST.

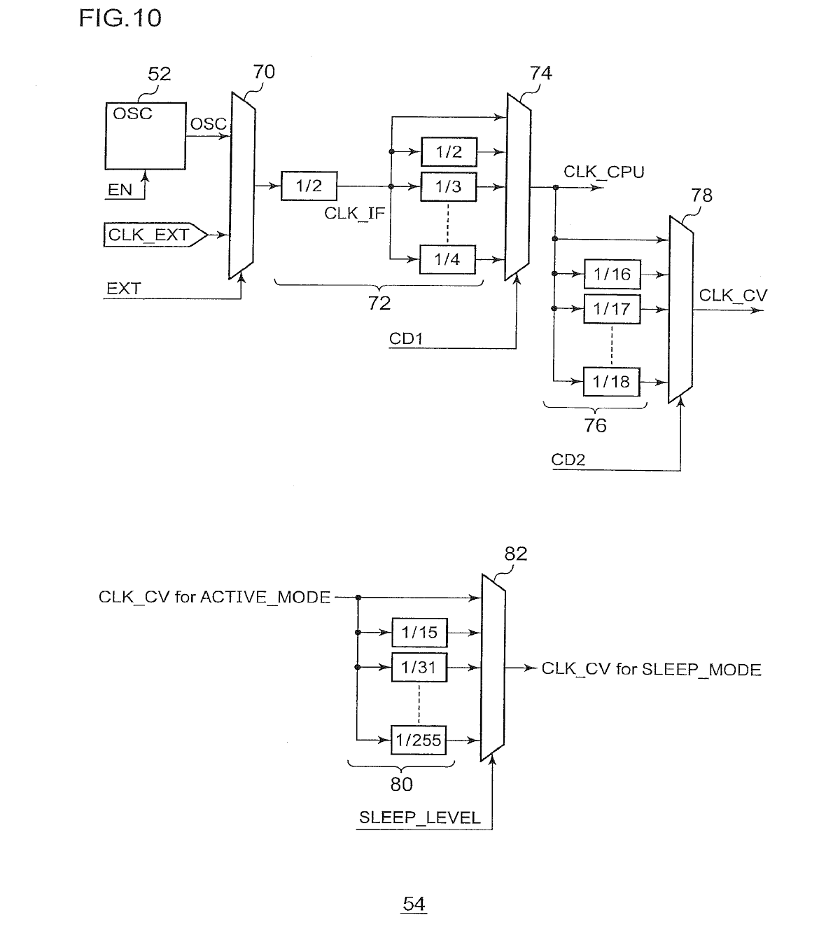

An external clock signal EXTCLK is input to an external clock terminal EXT_CLK. The oscillator 52 generates an internal clock signal OSC. The clock control unit 54 generates a CPU clock CLK_CPU used by the CPU core 38 and a clock CLK_CV used in the CV conversion performed by the C/V conversion control unit 30, based upon either the internal clock signal OSC or the external clock EXTCLK. FIG. 10 is a block diagram which shows a configuration of the clock control unit 54. The clock control unit 54 includes a first selector 70, a first frequency divider unit 72, a second selector 74, a second frequency divider unit 76, and a third selector 78.

The first selector 70 selects either the internal clock OSC or the external clock signal EXTCLK according to the control signal EXT. The first frequency divider unit 72 receives the clock signal output from the first selector 70, and divides the clock signal by multiple different division ratios, thereby generating multiple clock signals CLK_F with different frequencies. Specifically, the input device 2 generates a halved clock signal, a quartered clock signal, a sixthed clock signal, and an eighthed clock signal. The second selector 74 selects one of the multiple clock signals CLK_IF thus generated, according to a control signal CD1. The output clock output from the second selector 74 is supplied to the CPU core 38 as the CPU clock CLK_CPU.

The second frequency divider unit 76 divides the CPU clock CLK_CPU with multiple different division ratios, thereby generating multiple clock signals with different frequencies. The third selector 78 selects one from among the multiple clock signals thus generated, according to a control signal CD2, and supplies the clock signal thus selected to the C/V conversion control unit 30 as the CV conversion clock CLK_CV.

CLK_CPU=OSC/2/(DIV 1+1)

CLK_CV=OSC/2/(DIV 2+15)

Returning to FIG. 7, the detection IC 100 operates in a mode which can be switched between the following three modes.

Active mode φ_{ACT}: The state in which the capacitance of each sensor electrode SE is detected.

Sleep mode φ_{SLP} The state in which the sensing interval (by means of the cycle period of the multiplexer 32) is set to be longer than it is in the active state. The sensing interval is controlled according to the sleep level SLP_LEVEL.

Deep sleep (shutdown) mode φ_{SD}: the mode in which all functions are turned off, thereby reducing the current consumption to the minimum value. In this case, the set values are not stored. Accordingly, a reset is required to restore operations.

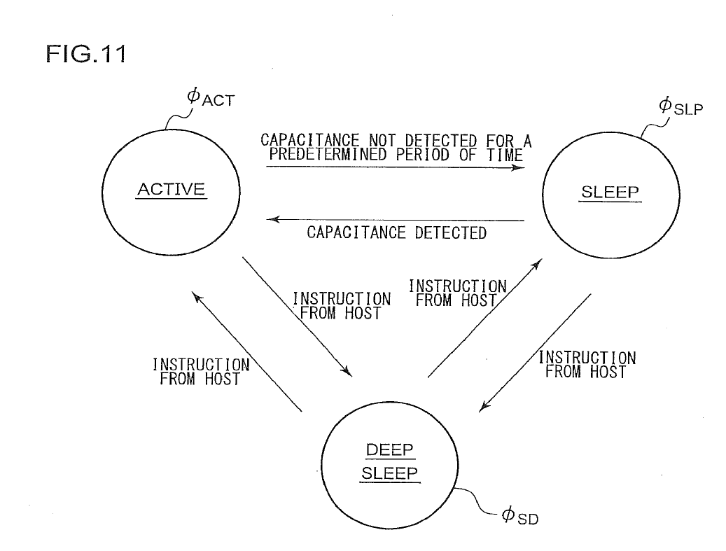

FIG. 11 is a state transition diagram which shows the transitions between these three modes.

(1) Transition to the shutdown mode φ_{SD} and return from the shutdown mode φ_{SD} occur according to an instruction from the host.

(2) Transition from the active mode φ_{ACT} to the sleep mode φ_{SLP} occurs when there is no change in the capacitance over a predetermined period of time. The predetermined period of time can be set according to control data SLP TIME. The sleep level SLP_LEVEL is a parameter which determines the sensing rate in the sleep state φ_{SLP}. The sensing rate in the sleep mode φ_{SLP}, is obtained by dividing the sensing rate in the active mode φ_{ACT} by (SLP_LEVEL×16). As the sensing rate is lowered, the current consumption can be reduced in the sleep mode. It should be noted that excessively lowering the sensing rate leads to a problem in that the return to the active mode φ_{ACT} is performed at a low speed.

(3) After the change in capacitance is detected in the sleep mode φ_{SLP}, the mode immediately transits to the active mode φ_{ACT}.

The sensing rate is determined according to the CLK_CV. The lower diagram in FIG. 10 shows a circuit configured to control the frequency of the clock signal CLK_CV in the sleep state φ_{SLP} according to the sleep level signal SLP_LEVEL. The clock control unit 54 further includes a third frequency divider 80 and a fourth selector 82. The third frequency divider 80 divides the clock signal CLK_CV with multiple different division ratios in the active mode φ_{ACT}. The fourth selector 82 selects, according to the sleep level signal SLEEP_LEVEL, one of the multiple clock signals having different frequencies output from the third frequency divider 80. The clock signal thus selected by the fourth selector 82 is supplied to the capacitance detection circuit 10.

Returning to FIG. 7, the detection IC 100 includes a resolution setting function. This function can be disabled according to the register settings. Specifically, this function is a function whereby, in a case in which the resolution provided by the detection IC 100 does not match the resolution requested by the system, the detection IC 100 is instructed to provide the resolution that matches that requested by the system.

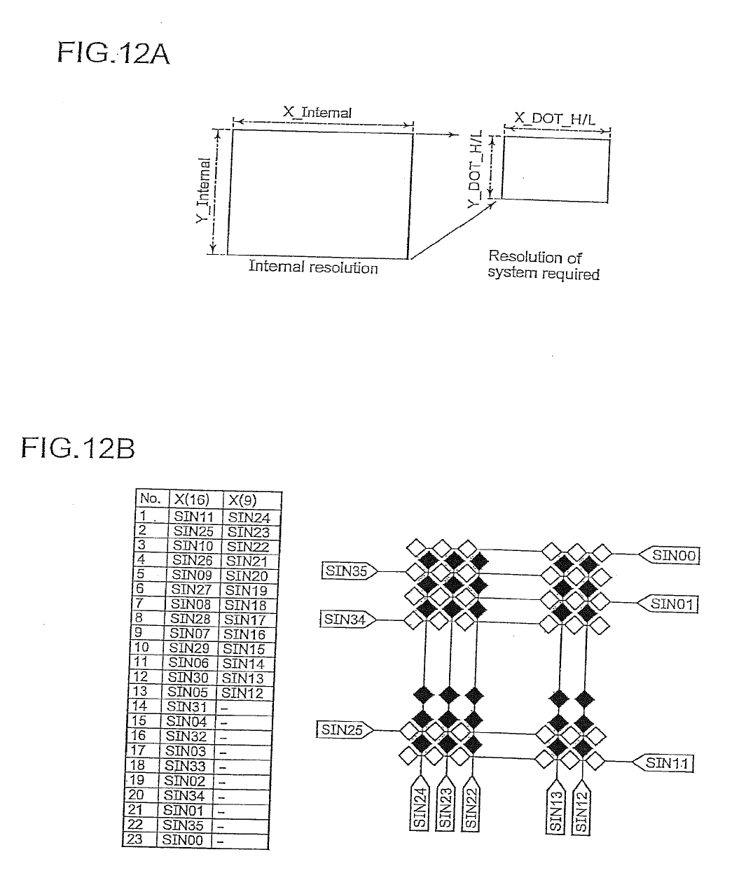

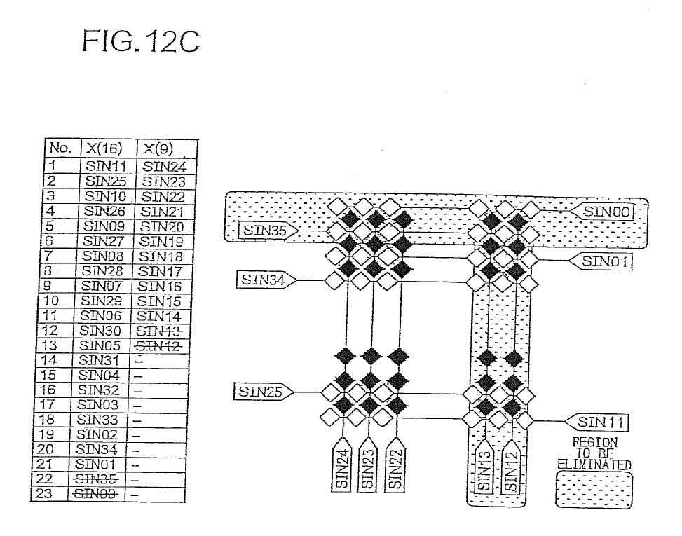

FIGS. 12A through 12C are diagrams for describing the resolution setting function. In FIG. 12A, the left-hand diagram shows the internal resolution provided by the detection IC 100, and the right-hand diagram shows the resolution requested by the system. FIG. 12B shows the state in which all the sensors are enabled in a case in which the aspect ratio is set to 16:9 (A mode). FIG. 12C shows the state in which the sensors of two rows and two columns are disabled. The detection IC 100 has a configuration which allows the sensors to be disabled in descending order of sensor number (No.). In this example, the sensors SIND00 and SIN35, respectively assigned to No. 23 and No. 22 in the X direction, are disabled, and the sensors SIN12 and SIN13, respectively assigned to No. 13 and No. 12 in the Y direction, are disabled. The term “disable” as used here means that the sensor thus disabled is not subjected to the scanning operation for capacitance detection. In a case in which the resolution is further reduced, the sensors assigned in the X direction are disabled in descending order of sensor number, i.e., No. 21, 20, and the sensors assigned in the Y direction are disabled in descending order of sensor number, i.e., No. 11, 10, . . . .

While the preferred embodiments of the present invention have been described using specific terms, such description is for illustrative purposes only, and it is to be understood that changes and variations may be made without departing from the spirit or scope of the appended claims.

What is claimed is:

1. A touch-type input device comprising:
a plurality of sensor electrodes arranged in a first coordinate axis direction, each of which is configured such that its electrostatic capacitance changes according to the circumstances of how a user touches the sensor electrodes;
a capacitance detection circuit configured to measure the electrostatic capacitances of the plurality of sensor electrodes, and to generate a first data array containing capacitance value data which represents the electrostatic capacitances thus measured;
a peak detection unit configured to scan the first data array, to identify the sensor electrode which exhibits the largest capacitance value, and to generate first peak data which represents the sensor electrode thus identified; and
a computation processing unit configured to reduce the value of the capacitance data of each sensor electrode arranged in a range within the capacitance data contained in the first data array so as to generate a second data array, with the range having been selected using the sensor electrode indicated by the first peak data as a reference,
wherein the peak detection unit scans the second data array, identifies the sensor electrode which exhibits the largest capacitance value, and generates second peak data which represents the sensor electrode thus identified.

2. A touch-type input device according to claim 1, wherein the computation processing unit reduces the value of the capacitance data that correspond to each sensor electrode arranged in the range to a predetermined value.

3. A touch-type input device according to claim 2, wherein the predetermined value is a judgment threshold value which is used to judge whether each sensor electrode is on or off.

4. A touch-type input device according to claim 2, wherein the predetermined value is zero.

5. A touch-type input device according to claim 1, wherein the range is a range of which one end corresponds to the sensor electrode indicated by the first peak data, and the other end of which corresponds to a sensor electrode that is a predetermined distance away in the direction opposite to the scanning direction.

6. A touch-type input device according to claim 1, wherein the range is a range of which the center corresponds to the sensor electrode indicated by the first peak data.

7. A touch-type input device according to claim 1, wherein the range is determined based upon the width of a standard user's finger and the intervals between the plurality of sensor electrodes.

8. A control method for a touch-type input device having a plurality of sensor electrodes arranged in a first coordinate axis direction, the electrostatic capacitance of each of which is configured to change according to the circumstances of how a user touches the sensor electrodes, comprising:
measuring the electrostatic capacitances of the plurality of sensor electrodes so as to generate a first data array containing capacitance value data which represents the electrostatic capacitances thus measured;
scanning the first data array so as to identify the sensor electrode which exhibits the largest capacitance value;
reducing the value of the capacitance data of each sensor electrode arranged in a range within the capacitance data contained in the first data array so as to generate a second data array, with the range having been selected using the sensor electrode indicated by the first peak data as a reference; and
scanning the second data array so as to identify the sensor electrode which exhibits the largest capacitance value.

9. A control method according to claim 8, wherein, in generating the second data array, the value of the capacitance data that correspond to each sensor electrode arranged in the range is reduced to a predetermined value.

10. A control method according to claim 9, wherein the predetermined value is a judgment threshold value which is used to judge whether each sensor electrode is on or off.

11. A control method according to claim 9, wherein the predetermined value is zero.

12. A control method according to claim 8, wherein one end of the range corresponds to the sensor electrode identified in scanning the first data array, and the other end of the range corresponds to a sensor electrode that is a predetermined distance away in the direction opposite to the scanning direction.

13. A control method according to claim 8, wherein the center of the range corresponds to the sensor electrode identified in scanning the first data array.

14. A touch-type input device provided at such a position that it is overlaid on a circuit which functions as a source of noise, and having a structure in which a substrate, sensor electrodes, and a cover which covers the sensor electrodes are layered in this order,
wherein the cover has a higher dielectric constant than that of the substrate.

15. A touch-type input device according to claim 14, further comprising:
a noise filter configured to remove noise from capacitance value data measured by the capacitance detection circuit;
a calibration control unit configured to cancel out irregularities in parasitic capacitance in increments of sensor electrodes of the plurality of sensor electrodes;
working data memory configured to be used by a CPU including the peak detection unit and the computation processing unit;
program memory configured to store a program to be executed by the CPU;
a register configured to be accessed by an external circuit via an interface circuit;
an oscillator configured to generate an internal clock signal having a predetermined frequency; and
a clock control unit configured to convert the frequency of the internal clock signal into frequencies suitable for the CPU and the capacitance detection circuit, and to output the clock signals thus converted.

16. A touch-type input device according to claim 15, wherein the clock control unit comprises:
a first frequency divider unit configured to divide the internal clock with a plurality of different division ratios;
a second selector configured to select one, according to a control signal, from among the plurality of clock signals having different frequencies output from the first frequency divider unit, and to output the clock signal thus selected to the CPU;
a second frequency divider unit configured to divide, with a plurality of different division ratios, the clock signal thus output from the second selector; and
a third selector configured to select one, according to a control signal, from among the plurality of clock signals having different frequencies output from the second frequency divider unit.

17. A touch-type input device according to claim 15, wherein the mode can be switched between:
an active mode wherein the capacitance detection circuit measures the electrostatic capacitances of the plurality of sensor electrodes at a predetermined rate;
a sleep mode wherein the capacitance detection circuit measures the electrostatic capacitances of the plurality of sensor electrodes at a rate lower than that of the active mode; and
a sleep mode wherein the current consumption is reduced to a minimum value.

18. A touch-type input device according to claim 15, configured such that, where the resolution provided by the touch-type input device does not match the resolution requested by a system, the capacitance detection circuit disables capacitance measurement for a part of the plurality of sensor electrodes, thereby enabling the resolution provided by the touch-type input device to match the resolution requested by the system.
